(19) United States
(12) Patent Application Publication
(10) Pub. No.: US 2026/0364895 A1
(43) Pub. Date: Nov. 19, 2026

(54) Device, System and Process for Producing Molded Parts

(71) Applicant: SIEMPELKAMP MASCHINEN-UND ANLAGENBAU GMBH, Krefeld (DE)

(72) Inventors: Fabian Köffers, Krefeld (DE); Michael Schöler, Rheurdt (DE); Klaus Schürmann, Jüchen (DE); Andre Bossmann, Sonsbeck (DE); Daniela Brömmel, Mönchengladbach (DE)

(21) Appl. No.: 19/144,026

(22) PCT Filed: Dec. 20, 2023
(86) PCT No.: PCT/EP2023/086998

§ 371 Date: Jun. 27, 2025

(30) Foreign Application Priority Data
Dec. 29, 2022 (DE) 10 2022 134 988.8

(51) Int. Cl. B29C 70/44

(52) U.S. Cl. CPC B29C 70/44

(57) ABSTRACT

A device for producing molded parts, in particular from fiber composite material, is shown and described, including a first pressing tool, a second pressing tool, and at least one membrane for contacting a workpiece, wherein the first pressing tool and the second pressing tool are movable relative to one another between an open position and a closed position, wherein a cavity for a working medium is formed between the membrane and the first pressing tool and/or the second pressing tool at least in the closed position, wherein a working space for receiving the workpiece is formed between the first pressing tool and the second pressing tool, in particular between the membrane and the first pressing tool (2) and/or the second pressing tool, and wherein the membrane has a membrane thickness, a longitudinal extension and a transverse extension. In order to provide a device which enables uniform application of pressure and/or temperature to molded parts with both complex and less complex geometry, it is proposed that the membrane; has, in particular along the longitudinal extension and/or the transverse extension of the membrane, at least one elastically deformable base section for contacting the workpiece and at least one plastically pre-deformed shaped section for contacting the workpiece.

### CROSS-REFERENCE TO RELATED APPLICATIONS

This application is the United States national phase of International Patent Application No. PCT/EP 2023/086998 filed Dec. 20, 2023, and claims priority to German Patent Application No. 10 2022 134 988.8 filed Dec. 29, 2022, the disclosures of which are hereby incorporated by reference in their entireties.

### BACKGROUND OF THE INVENTION

### Field of the Invention

The invention relates to a device for producing molded parts, in particular from fiber composite material, comprising a first pressing tool, a second pressing tool, and at least one membrane for contacting a workpiece, wherein the first pressing tool and the second pressing tool are movable relative to one another between an open position and a closed position, wherein at least in the closed position a cavity for a working medium is formed between the membrane and the first pressing tool and/or the second pressing tool, wherein a working space for receiving the workpiece is formed between the first pressing tool and the second pressing tool, in particular between the membrane and the first pressing tool and/or the second pressing tool, and wherein the membrane has a membrane thickness, a longitudinal extension and a transverse extension.

The invention also relates to a system for producing molded parts, in particular from fiber composite material, comprising: a workpiece, and a device for producing molded parts described herein.

The invention also relates to a process for producing molded parts, in particular from fiber composite material, comprising the following steps: a) providing a workpiece, b) providing a device for producing molded parts according to any one of claims 1 to 21, and c) applying pressure and/or temperature to the workpiece by means of the device for producing molded parts.

### Description of Related Art

Fiber composite materials are composite materials that substantially consist of two main components: reinforcing fibers and a plastic in which the fibers are embedded (“matrix” or “resin”). By combining the two main components, it can be achieved that the composite material has better overall properties than the two components alone. For example, the fibers contribute to increasing the tensile strength of the composite material due to their high tensile strength in the fiber direction. The matrix, on the other hand, ensures that the fibers are held in position and protected from mechanical and chemical influences.

One of several options for producing molded parts from fiber composite materials is based on the use of prefabricated fiber-resin semi-finished products (so-called “prepregs”, short for “preimpregnated fibers”). In such semi-finished products, the fibers are provided with a resin system that has not yet fully reacted, so that the semi-finished products are still available in a flexible form (e.g. in sheet form, on rolls). The prepregs are only formed and cured at high pressure and high temperatures by means of the completion of the chemical reaction when the molded parts are produced. This step can take place in a press, for example.

Prepregs are processed in large quantities in the aerospace industry, for example. One challenge in processing is that the aerospace industry often requires very complex molded part geometries, for example due to reinforcing elements such as stringers. Moreover, it is also intended to reduce assembly costs, which can be achieved by using fewer but larger molded parts. The combination of complex geometries and large molded part dimensions leads to increased requirements on the devices and processes used to produce these molded parts.

A device and a process for producing molded parts made from fiber composite material are known, for example, from DE 10 2017 113 595 A1. A uniform application of pressure to the molded part to be produced is to be achieved by an elastic membrane acting on the workpiece from which the molded part is to be formed, wherein an oil pressure is acting on the membrane from the side of the membrane facing away from the workpiece. The membrane is thus pressed onto the workpiece surface by an oil pressure and thus takes on the shape of the workpiece. In this way, even with curved workpiece surfaces or molded part surfaces, it should be ensured that the oil pressure acts on all sides and thus the force acting from the membrane on the workpiece surface is the same at every point, in particular also the force component acting orthogonally on the workpiece surface. However, the disadvantage here is that the membrane can only be elastically deformed to a certain degree before damage occurs to the membrane. Molded parts with complex geometries, in particular with strong changes in curvature and/or opposite curvatures, cannot be produced with such a device.

The use of such a “membrane press” for the production of molded parts made from fiber composite material is also known from US 2016/0297153 A1. However, the disadvantage here is that only a rigid wall is provided for contact with the workpiece or molded part. Although the rigid wall can be connected to a flexible membrane, the flexible membrane is not intended for contact with the workpiece. Particularly in areas of the workpiece or molded part with less complex geometries, such a rigid wall cannot or not sufficiently adapt to the geometry of the workpiece or molded part by elastic deformation and therefore does not allow uniform application of pressure and/or temperature.

### SUMMARY OF THE INVENTION

The invention is therefore based on the object of providing a device, a system and a process for producing molded parts, in particular from fiber composite material, which enable uniform application of pressure and/or temperature to molded parts with complex as well as less complex geometry.

This object is solved in a device according to the preamble of claim 1 in that the membrane has, in particular along the longitudinal extension and/or the transverse extension of the membrane, at least one elastically deformable base section for contacting the workpiece, in particular also the molded part to be produced, and at least one plastically pre-deformed shaped section for contacting the workpiece, in particular also the molded part to be produced. The combination of elastically deformable base section, which can adapt very well elastically to less complex geometries of the shape of the workpiece or the molded part to be produced from the workpiece, and plastically pre-deformed shaped section, which is adapted to particularly complex geometries of the shape of the workpiece or the shape of the molded part to be produced from the workpiece by the plastic pre-deformation even before pressure and/or temperature is applied to the workpiece, allows geometries of varying complexity to be subjected particularly uniformly to pressure and/or temperature.

The longitudinal extension of the membrane is the extension of the membrane, in particular starting from a transverse side of the membrane, along the longitudinal axis of the membrane. The transverse extension of the membrane is the extension of the membrane, in particular starting from a longitudinal side of the membrane, along the transverse axis of the membrane. The transverse extension of the membrane does not have to run exclusively in the direction of the transverse axis or may not run at all in some sections. If, for example, the membrane extends at least in sections in an arc around the longitudinal axis of the membrane, the transverse extension of the membrane runs proportionally in the direction of the transverse axis of the membrane and proportionally in the direction of the height axis of the membrane. The same applies to the longitudinal extension of the membrane. The height axis of the membrane is the axis perpendicular to the longitudinal axis of the membrane and perpendicular to the transverse axis of the membrane. The longitudinal axis of the membrane and the transverse axis of the membrane are in turn perpendicular to each other.

The device comprises a first—preferably upper—pressing tool and a second—preferably lower—pressing tool, but the device can also comprise further pressing tools. The first pressing tool and/or the second pressing tool can be designed in one-piece or in multiple pieces. The first pressing tool and/or the second pressing tool are preferably made of metal, in particular nickel-rich steel, nickel-rich cast iron or nickel-rich cast steel. The respective nickel content can be above 34%, preferably between 35.7% and 36.7% or between 40.8% and 43.6%. By using metal, especially steel, a long service life of the pressing tools can be achieved. In the case of steels, such as Invar 36, for example, they also have a very low coefficient of thermal expansion. The use of Invar therefore enables very precise production of molded parts, even with changing temperatures during the pressing process. Even greater advantages can be achieved with specially adapted casting alloys, preferably nickel-rich cast iron or nickel-rich cast steel, with which not only the maximum coefficient of thermal expansion can be kept low, but can also be adapted to the requirements of the workpiece material, for example a (glass or carbon fiber reinforced) thermoset or a (glass or carbon fiber reinforced) thermoplastic material, over large parts of the heating and cooling process in the pressing cycle. In addition, the use of cast materials offers considerable economic advantages, as high-nickel alloyed steels are extremely expensive and the machining rates in mold making are still often well over 50%, usually even over 70% or 80%.

The first pressing tool and the second pressing tool are moveable relative to each other between an open position and a closed position. This allows the pressing tools to be moved towards and away from a workpiece inserted into the press or the molded part produced from the workpiece. The first pressing tool and the second pressing tool are moveable relative to each other in particular along an axis of movement between the open position and the closed position. This ensures a defined movement of the pressing tools. In the open position, the workpiece can be inserted between the pressing tools or the finished molded part can be removed between the two pressing tools. In the closed position, pressure and/or temperature can be applied to the workpiece in order to produce the molded part from the workpiece.

The device also comprises at least one membrane. The membrane is provided for contacting the workpiece, in particular also the molded part to be produced, and in particular for applying pressure and/or temperature to the workpiece. For this purpose, the membrane is movable, in particular expandable, at least in sections in the direction of the working space. The membrane comprises at least one base section and at least one shaped section. The membrane can advantageously comprise at least two base sections, in particular a plurality of base sections, and/or at least two shaped sections, in particular a plurality of shaped sections. The base section is elastically, in particular linearly-elastically, deformable and can therefore adapt very well to the shape of the workpiece or the molded part to be produced. The shaped section is in turn plastically pre-deformed. This means that a shape has been imprinted on the shaped section by plastic deformation, particularly relative to the base section. The shaped section has been additionally plastically deformed relative to the base section as a result of the plastic pre-deformation. The plastic pre-deformation takes place beyond the elastic limit of the material of the membrane. The plastic pre-deformation preferably leads to a plastic deformation at least on the side of the shaped section adjoining the cavity and/or at least on the side of the shaped section adjoining the working space, in particular substantially over the entire membrane thickness of the shaped section. The shape, in particular imprinted by plastic pre-deformation, of the shaped section advantageously deviates from the basic shape of the membrane, in particular the basic shape of the base section, at least in the open position of the pressing tools, in particular in the unloaded state of the membrane. The aim of the plastic pre-deformation is to adapt the shaped section at least in sections to the shape of the workpiece or the molded part to be produced from the workpiece with the device. By means of plastic pre-deformation, the shaped section can be brought into a shape that the membrane could not reach by elastic, in particular linear-elastic, deformation during production of the molded part. The plastic pre-deformation of the shaped section thus results in a controlled adaptation of the shape of the shaped section and thus the shape of the membrane, instead of an uncontrolled plastic deformation of the membrane when pressure and/or temperature is applied. Uncontrolled plastic deformation of the membrane can lead to damage to the membrane. The shaped section does not have to be completely plastically pre-deformed; it is preferably sufficient for the shaped section to be plastically pre-deformed at least in sections, preferably predominantly plastically pre-deformed. However, it can also be advantageous if the shaped section is substantially completely plastically pre-deformed.

The plastic pre-deformation of the shaped section does not, for example, mean a general plastic deformation of the entire starting material used for the membrane, for example in a rolling mill, or a plastic deformation which the membrane may undergo during the production of a molded part when pressure and/or temperature is applied. The shaped section is advantageously plastically pre-deformed, in particular with respect to the base section, at least on the side of the shaped section adjoining the cavity and/or at least on the side of the shaped section adjoining the working space.

The base section and the shaped section of the membrane are provided in particular along the longitudinal extension and/or the transverse extension of the membrane. The base section and the shaped section advantageously extend along the longitudinal extension and/or the transverse extension of the membrane. Preferably, the base section and the shaped section adjoin one another, in particular along the longitudinal extension and/or the transverse extension of the membrane.

The device can also comprise two or at least two membranes. By using two or at least two membranes, pressure and/or temperature can be transferred to the workpiece from different sides in a simple manner. Advantageously, the membrane thickness is at least 0.05 mm, preferably at least 0.2 mm, in particular at least 0.25 mm. This ensures sufficient strength of the membrane. Alternatively or additionally, the membrane thickness is at most 4 mm, preferably at most 2 mm, in particular at most 1.5 mm. This ensures sufficient flexibility of the membrane, especially in the area of the base section. The membrane is preferably formed as a single piece and/or one-piece, in particular made from a single sheet metal. However, it may also be sufficient if only the base section and the shaped section are formed one-piece together, in particular if they are made from a single sheet.

A cavity for a working medium is formed between the membrane and the first pressing tool and/or the second pressing tool, at least in the closed position. The cavity can also form between the membrane and the first pressing tool and/or the second pressing tool in the open position and the closed position, preferably in each position of the pressing tools. The cavity is preferably delimited at least in sections by the membrane and the first pressing tool and/or the second pressing tool. The cavity advantageously has the same thickness, in particular along the longitudinal and/or transverse extension of the membrane, at every point between the membrane and the first pressing tool and/or the second pressing tool. The cavity can be filled with a working medium. The working medium is, for example, a gas or a liquid. Pressure and/or temperature can also preferably be applied to the working medium. The pressure and/or temperature that can be applied to the working medium can be transferred to the workpiece by means of the membrane. The cavity can also advantageously be expanded in the direction of the working space. The cavity can be subjected to an oil pressure of at least 0.1 bar, preferably at least 2 bar, more preferably at least 6 bar, in particular at least 8 bar and/or at most 40 bar, preferably at most 26 bar, in particular at most 22 bar. The cavity can preferably also be sealed against an oil pressure of at least 4 bar, advantageously at least 8 bar, in particular at least 40 bar, by the first pressing tool and/or the second pressing tool and the membrane.

Between the first pressing tool and the second pressing tool, in particular between the membrane and the first pressing tool and/or the second pressing tool, a working space for receiving the workpiece is also formed. The working space is preferably formed at least in the open position and/or at least in the closed position, in particular in each position of the pressing tools. The workpiece can then be introduced into the working space in the open position and can be applied with pressure and/or temperature in the closed position, in particular by means of the membrane.

According to a first embodiment of the device, it is provided that, at least in the open position, the shaped section is plastically pre-deformed relative to the base section, in particular along the longitudinal extension and/or the transverse extension of the membrane. The shaped section thus has an additional plastic deformation compared to the base section, by means of which the shaped section is adapted in particular to complex geometries of the workpiece or the molded part to be produced. Advantageously, in at least the open position and the closed position, preferably in every position of the pressing tools, the shaped section is plastically pre-deformed relative to the base section.

According to a further embodiment of the device, it is provided that the membrane is made of metal, preferably steel, in particular stainless steel. In simple cases, it may be sufficient to use a stainless steel according to material specification 1.4301 to produce the membrane. Preferably, however, steel, in particular stainless steel, with good to excellent deep-drawing properties, i.e. so-called deep-drawing steel, should be used to produce the membrane. The use of metal provides a sufficiently stable membrane that can also withstand high pressures and/or high temperatures and itself has high thermal conductivity. In addition, a membrane made of metal can be deformed both elastically and plastically. The use of a membrane made of metal with a plastically pre-deformed section in particular allows molded parts with complex geometries and under high pressures and/or temperatures to be produced, which would not be possible with non-metallic membranes, such as silicone membranes. Although silicone membranes, for example, can adapt well to complex geometries of the workpiece or the molded part to be produced, silicone membranes can only withstand lower pressures and/or temperatures than membranes made of metal. The disadvantage of the lower flexibility of a metal membrane compared to a silicone membrane, for example, is compensated for in the present case by the plastically pre-deformed shaped section, which is adapted to sections of the workpiece or the molded part to be produced with complex geometries. Advantageously, the shaped section and the base section are also made from the same metal. The membrane can have a tensile strength of 300 to 850 MPa, in particular 310 to 540 MPa or 490 to 830 MPa. In particular, the membrane can be made of a steel that comprises at least the following proportions in percent by weight as elements or as compounds of:
carbon in the range of approx. 0.16% to 0.22%,
Silicon up to approx. 0.13%,
Manganese in the range of approx. 0.2% to 0.4%,
Nickel up to approx. 0.25%,
Sulphur up to approx. 0.025%
Phosphorus up to approx. 0.025%,
Chromium up to approx. 0.15%,
Aluminum in the range of approx. 0.02% to 0.07%,
Copper up to approx. 0.2%,
   the remainder being iron and unavoidable impurities. For example, the membrane can be made of hot-annealed steel strip or hot-rolled steel strip according to GOST 2284-79.

Other steel alloys containing chromium, nickel and, advantageously, titanium and/or copper can also achieve good results.

A further embodiment of the device provides for that the base section is more elastically deformable than the shaped section and/or that the membrane, in particular the base section, is deformable by elastic deformation in the direction of the working space. This allows the base section to adapt particularly well to the geometry of the workpiece or the molded part to be produced. The greater elastic deformability of the base section compared to the shaped section is in particular due to the plastic pre-deformation of the shaped section. In particular, the base section is more linearly elastically deformable than the shaped section. Despite the plastic pre-deformation of the shaped section, however, the shaped section is preferably elastically deformable. Advantageously, the base section is more elastically, in particular linearly elastically, deformable than the shaped section at least on the side of the base section adjoining the cavity and/or at least on the side of the base section adjoining the working space. In particular, the shaped section is also more plastically deformed than the base section, at least in the open position. Due to the greater plastic deformation, the shaped section is particularly well adapted in advance to the geometry of the workpiece or the molded part to be produced. Alternatively or additionally, the membrane, in particular the base section, can be deformed in the direction of the cavity by elastic deformation.

According to one embodiment of the device, it is provided that, at least in the open position, the curvature of the shape of the shaped section, in particular along the longitudinal extension and/or transverse extension of the membrane, deviates at least in sections from at least one curvature of the shape of the base section, preferably from the curvature of the shape of the edge region of the base section adjoining the shaped section. This provides a pre-deformation of the shaped section that is adapted to the geometry of the workpiece or the molded part to be produced. In particular, the curvature of the shape of the shaped section can deviate in amount and/or sign from the at least one curvature of the shape of the base section. The shaped section thus has a change in curvature compared to the base section, so that the shaped section and the base section extend in different directions at least in sections. The shape of the shaped section or the shape of the base section describes the general shape of the respective section. Shape deviations as described in DIN 4760:1982-06, preferably at least 2nd order and/or at least 3rd order and higher order shape deviations, are not regarded as part of the shape and not as part of the curvature of the shape. The 2nd order shape deviation is the waviness and the 3rd to 5th order shape deviations are the roughness. The curvature of the shape is therefore not a defect, in particular a surface defect, of the membrane. In particular, the curvature of the shape of the shaped section is at least in sections by at least a factor of 1.05, preferably at least a factor of 1.25, further preferably at least a factor of 2, further preferably at least a factor of 4, further preferably at least a factor of 10, further preferably at least a factor of 25, further preferably at least a factor of 50, further preferably at least a factor of 100, further preferably at least a factor of 250, further preferably at least a factor of 500, further preferably at least a factor of 1000, further preferably at least a factor of 2500, further preferably at least a factor of 5000, in particular at least a factor of 10000, smaller or larger than the at least one curvature of the shape of the base section, preferably the curvature of the shape of the edge region of the base section adjoining the shaped section.

The at least sectional deviation of the curvature between the shape of the shaped section and the at least one curvature of the shape of the base section is advantageously generated by the plastic pre-deformation of the shaped section, in particular with respect to the base section. The deviation of the curvature should, for example, therefore not or at least not substantially be a deviation of the curvatures due to elastic deformation of the membrane, in particular due to the force of gravity.

According to one embodiment of the device, it is provided that, at least in the open position, the curvature of the shape of the shaped section on the side of the shaped section adjoining the cavity deviates at least in sections from the at least one curvature of the shape of the base section, preferably from the curvature of the shape of the edge region of the base section adjoining the shaped section, on the side of the base section adjoining the cavity and/or the curvature of the shape of the shaped section on the side of the shaped section adjoining the working space deviates at least in sections from the at least one curvature of the shape of the base section, preferably from the curvature of the shape of the edge region of the base section adjoining the shaped section, on the side of the base section adjoining the working space. This provides a pre-deformation of the shaped section adapted to the geometry of the workpiece or molded part to be produced. It is particularly advantageous here if both the curvatures on the respective side adjoining the working space and the curvatures on the respective side adjoining the cavity differ from each other, as this enables a particularly extensive adaptation of the shaped section to the geometry of the workpiece or the molded part to be produced.

A further embodiment of the device is characterized by the fact that, at least in the open position, the curvature of the shape of the shaped section, in particular along the longitudinal extension and/or transverse extension of the membrane, is designed at least in sections opposite to the at least one curvature of the shape of the base section, preferably to the curvature of the shape of the edge region of the base section adjoining the shaped section. This provides a pre-deformation of the shaped section that is adapted to the geometry of the workpiece or molded part to be produced. In particular, this provides a shaped section that is pre-deformed to match the more complex geometries of the workpiece or molded part to be produced. Opposite curvatures means that the curvatures have different signs. For example, the base section can be curved to the left and therefore have a positive sign, and the shaped section can be curved to the right and therefore have a negative sign, or not be curved, in which case the curvature is zero and the curvature has no sign. A positive sign, a negative sign and no sign are to be regarded as different signs.

The at least in sections opposite curvature between the shape of the shaped section and the at least one curvature of the shape of the base section is advantageously generated by the plastic pre-deformation of the shaped section, in particular with respect to the base section. The opposite curvatures should, for example, therefore not or at least not substantially be caused by elastic deformation of the membrane, in particular due to gravity.

According to one embodiment of the device, it is provided that, at least in the open position, the curvature of the shape of the shaped section on the side of the shaped section adjoining the cavity is at least in sections opposite to the at least one curvature of the shape of the base section, preferably to the curvature of the shape of the edge region of the base section adjoining the shaped section, on the side of the base section adjoining the cavity and/or the curvature of the shape of the shaped section on the side of the shaped section adjoining the working space is at least in sections opposite to the at least one curvature of the shape of the base section, preferably to the curvature of the shape of the edge region of the base section adjoining the shaped section, on the side of the base section adjoining the working space. This provides a pre-deformation of the shaped section that is adapted to the geometry of the workpiece or the molded part to be produced. It is particularly advantageous here if both the curvatures on the respective side adjoining the working space and the curvatures on the respective side adjoining the cavity are designed opposite, as this enables a particularly extensive adaptation of the shaped section to the geometry of the workpiece or the molded part to be produced.

A further embodiment of the device provides that the deviation of the curvature of the shape of the shaped section from the at least one curvature of the shape of the base section, preferably from the curvature of the shape of the edge region of the base section adjoining the shaped section, is generated by means of plastic deformation, in particular of the shape, of the shaped section. The deviation of the curvature, i.e. the deviation of the amount and/or the sign of the curvature, should thus be generated by the plastic pre-deformation of the shaped section. As a result, the shaped section is permanently adapted to the geometry of the workpiece or the molded part to be produced.

According to one embodiment of the device, it is provided that the curvature of the shape of the shaped section, which deviates from the at least one curvature of the shape of the base section, preferably from the curvature of the shape of the edge region of the base section adjoining the shaped section, extends, in particular along the longitudinal extension and/or the transverse extension of the membrane, over a length of at least 6 mm, preferably at least 50 mm, further preferably at least 70 mm, further preferably at least 100 mm, further preferably at least 150 mm, further preferably at least 500 mm, in particular at least 1000 mm. This provides a shaped section that is adapted to particularly complex geometries of the workpiece or the molded part to be produced and/or particularly large workpieces or molded parts to be produced. In the latter case, for example, changes in the direction of the membrane can be provided in an order of magnitude that would not be possible without plastic pre-deformation of the shaped section, particularly in the case of a membrane made of metal.

A further embodiment of the device provides that, at least in the open position, the shaped section and/or the base section, in particular the shape of the shaped section and/or the shape of the base section, are curved at least in sections about the longitudinal axis of the membrane or an axis parallel to the longitudinal axis of the membrane, about the transverse axis of the membrane or an axis parallel to the transverse axis of the membrane and/or about the height axis of the membrane or an axis parallel to the height axis of the membrane. This makes it easy to produce molded parts with complex geometries. In the case of the shaped section, this curvature is imprinted on the shaped section by the plastic pre-deformation. It is preferably provided that, at least in the open position, the shaped section and/or the base section, in particular the shape of the shaped section and/or the shape of the base section, are curved at least in sections about at least two of the axes from the group of longitudinal axis of the membrane or an axis parallel to the longitudinal axis of the membrane, transverse axis of the membrane or an axis parallel to the transverse axis of the membrane and height axis of the membrane or an axis parallel to the height axis of the membrane. In other words, it is advantageous if, at least in the open position, the shaped section and/or the base section, in particular the shape of the shaped section and/or the shape of the base section, are curved at least in sections about at least two axes extending perpendicular to one another. This provides a membrane which is double-curved at least in sections. This makes it easy to produce molded parts with a complex geometry, in particular a double curvature. Advantageously, it is provided that the shaped section, preferably the shape of the shaped section, is curved by plastic pre-deformation of the shaped section, preferably relative to the base section, at least in sections about at least two axes running perpendicular to each other.

According to one embodiment of the device, it is provided that, at least in the open position, the shaped section, in particular on the side of the shaped section adjoining the cavity and/or on the side of the shaped section adjoining the working space, is spaced apart by a distance at least in sections from the base section, in particular the edge region of the base section adjoining the shaped section, in the direction of the cavity and/or in the direction of the working space, in particular substantially perpendicular to the surface of the edge region of the base section adjoining the shaped section, and that the distance corresponds at least to the membrane thickness. This provides a shaped section that is adapted to the complex geometries of the workpiece or the molded part to be produced. In particular, the shaped section provides sufficient space for protrusions of the workpiece or the molded part to be produced therefrom already in the open position and also during the application of pressure and/or temperature to the workpiece. In addition, a shaped section designed in this way can be arranged sufficiently close to recesses of the workpiece or the molded part to be produced, so that a uniform contacting of the shaped section is achieved. A corresponding distance, for example in the direction of the cavity, can lead to a larger volume of the cavity, as the distance between the membrane and the pressing tool is generally increased throughout to achieve a sufficient distance between the shaped section and the pressing tool. This may result in higher acquisition costs, higher operating costs, a higher risk of leaks and increased inertia in temperature control, but the advantage is that a similar degree of uniformity of the pressure distribution acting in the pressing process is also achieved in the shaped section as is the case when considering the same overall process. Advantageously, the distance is present at least in the open position between the side of the shaped section adjoining the cavity and the side of the base section adjoining the cavity and/or between the side of the shaped section adjoining the working space and the side of the base section adjoining the working space. The distance can advantageously be at least 6 mm, preferably at least 15 mm, more preferably at least 50 mm, in particular at least 72 mm, more preferably at least 1000 mm. Alternatively or additionally, the distance can be at least 1.25 times, preferably at least 1.41 times, further preferably at least 7 times, further preferably at least 25 times, further preferably at least 50 times, in particular at least 100 times, the membrane thickness. Advantageously, the shaped section can also be spaced at the distance from the base section in the direction of the height axis.

A further embodiment of the device provides that, at least in the open position, the shaped section extends, in particular along the longitudinal extension and/or transverse extension of the membrane, at least in sections obliquely to the base section and that, preferably, between the shaped section and the base section there is, at least in sections, an angle of at least 90°, preferably at least 100°, in particular at least 120°, and/or an angle of at most 180°, preferably at most 160°, in particular at most 145°. This provides a membrane with a change in direction of a magnitude that would not be possible without plastic pre-deformation of the shaped section, particularly in the case of a membrane made of metal.

According to one embodiment of the device, it is provided that the shaped section extends, in particular along the longitudinal extension and/or the transverse extension of the membrane, at least 6 mm, preferably at least 50 mm, further preferably at least 70 mm, further preferably at least 100 mm, further preferably at least 150 mm, further preferably at least 500 mm, in particular at least 1000 mm. This provides a sufficiently large shaped section, which is also suitable for workpieces or molded parts to be produced with complex geometries of larger dimensions.

A further embodiment of the device provides that the membrane thickness of the shaped section deviates at most 40%, preferably at most 25%, further preferably at most 15%, in particular at most 10%, further in particular at most 5%, from the membrane thickness of the base section, in particular of the edge region of the base section adjoining the shaped section. This provides a membrane with a particularly uniform membrane thickness. In this case, the plastic pre-deformation of the shaped section has only a minor influence on the membrane thickness of the shaped section. The deviation of the membrane thickness is advantageously present along substantially the entire shaped section. Advantageously, the shaped section and the base section, in particular the edge area of the base section adjoining the shaped section, also have substantially the same membrane thickness.

One embodiment of the device provides that the membrane, in particular the base section and/or the shaped section, has at least in sections a surface structure and that, preferably, the surface structure is arranged on the side of the membrane adjoining the working space, in particular of the base section and/or the shaped section. In this way, a structure can be imprinted on the workpiece or the molded part to be produced. Advantageously, the surface structure may have mushroom-like, honeycomb-like, groove-like and/or finger-like surface structures in the micrometer or millimeter range. This preferably means that an extension of the surface structure, i.e. the height or depth of the elevation or indentation of the surface structure, is between 0.05 μm and 5 mm +/−10%. It is particularly preferred that the height or depth of the elevation or indentation of the surface structure is between 0.5 μm and 500 μm +/−10%. Alternatively or additionally, it may be provided that the surface structure has a regular pattern and/or is designed as sharkskin. It is preferable that the surface structure comprises not only a single elevation or indentation, but a plurality of elevations and/or indentations. These elevations and/or indentations are preferably not randomly distributed across the membrane, but are arranged in a regular pattern. In particular, it is envisaged that the surface structure of the membrane has a translational symmetry, i.e. it is a regularly repeating pattern. Preferably, it is a honeycomb-like surface structure, whereby a hexagonal elevation and/or indentation fills the surface with translational symmetry. Further preferred is a finger-like or mushroom-like elevation and/or indentation, wherein the pattern of the elevations and/or indentations can be described by one of the five two-dimensional Bravais lattices. The finger-like or mushroom-like structures of the membrane form an oblique-angled, a square, a rectangular, a hexagonal or a rectangular face-centered lattice. The surface structure of the membrane also preferably comprises hill-like elevations with sharp, pointed indentations. The membrane is preferably designed in such a way that the surface structure corresponds to an impression or negative of a riblet, also known as sharkskin.

A further embodiment of the device is characterized in that the surface of the membrane, in particular of the base section and/or the shaped section, has at least in sections an average surface roughness of less than 63 μm, preferably less than 12 μm, more preferably between 0.1 μm and 10 μm, in particular between 0.1 μm and 3 μm, preferably on the side of the membrane facing the working space. This provides a membrane with a particularly smooth surface, which in turn leads to a particularly smooth surface in a molded part to be produced.

According to one embodiment of the device, it is provided that the membrane is arranged at least in sections between the first pressing tool and the second pressing tool and/or that the first pressing tool and/or the second pressing tool is connected to the membrane. By connecting the membrane to one of the pressing tools, a defined mounting of the membrane is provided.

One embodiment of the device provides that the cavity is sealed at least in the closed position by at least one seal, that a sealing force can be applied to the membrane via the seal and that, preferably, the membrane is moveable relative to the seal. A corresponding seal prevents the working medium from leaking out of the cavity in a structurally simple manner. Since the membrane is movable relative to the seal, changes in the length of the membrane, in particular due to thermal expansion or thermal shrinkage, do not lead to overstressing of the membrane or uneven contact on the workpiece or the molded part to be produced. In addition, the mobility of the membrane relative to the seal simplifies pretensioning of the membrane, since a pretension can then be applied to the membrane outside the area sealed by the seal. Advantageously, the device comprises at least one device for changing the sealing force of the seal. In this way, a particularly tight seal of the cavity can be achieved.

A further embodiment of the device is characterized in that the first pressing tool and the second pressing tool are movable relative to one another along an axis of movement, that the first pressing tool and/or the second pressing tool has a first pressing plane and a second pressing plane and that the first pressing plane and the second pressing plane of the respective pressing tool are spaced apart from one another in the direction of the axis of movement. The production of molded parts with more complex geometries is further simplified by appropriately spaced press planes, as the shape of the pressing tool is thereby adapted to the geometry of the workpiece or the molded part to be produced and pressure and/or temperature can therefore be applied more evenly. Advantageously, the axis of movement runs horizontally or vertically. The axis of movement preferably runs substantially centrally through the first pressing tool and/or the second pressing tool. Alternatively or additionally, the axis of movement runs substantially centrally through the working space.

The shape of the first pressing tool and/or the second pressing tool, in particular the first pressing plane and/or the second pressing plane of the first pressing tool and/or the second pressing tool, corresponds at least on the side adjoining the working space and/or cavity to the shape of the membrane, preferably the shape of the shaped section, on the side adjoining the cavity and/or working space.

One embodiment of the device comprises at least one device for changing the pretension of the membrane. This has the advantage that the membrane is in uniform contact with the workpiece, in particular before or at the start of the application of temperature and pressure to the workpiece. The device for changing the pretension of the membrane can be realized, for example, by a spring with adjustable spring travel or adjustable pretension.

The task mentioned at the beginning is also solved by a system for producing molded parts, in particular from fiber composite material, comprising: a workpiece, and a device for producing molded parts according to any one of claims 1 to 21.

According to one embodiment of the system, it is provided that in the device for producing molded parts, the shape of the shaped section is at least in the open position adapted by plastic deformation at least in sections to the shape of the workpiece. This allows the membrane, particularly in the case of a membrane made of metal, to contact evenly the workpiece or the molded part to be produced, particularly in the case of workpieces or molded parts with complex geometry. Preferably, the shape of the shaped section is at least in the open position adapted at least in sections to the shape of the workpiece, by plastic pre-deformation of the shaped section.

The object mentioned at the beginning is also solved by a process for producing molded parts, in particular from fiber composite material, comprising the following steps: a) providing a workpiece, b) providing a device for producing molded parts according to any one of claims 1 to 21, and c) applying pressure and/or temperature to the workpiece by means of the device for producing molded parts. Advantageously, the process further comprises the step b1) inserting the workpiece into the device for producing molded parts. Preferably, the workpiece is inserted into the working space in step b1). In addition, in step b1) the pressing tools are advantageously in the open position. The process also preferably comprises step b2) moving the first pressing tool and the second pressing tool from the open position to the closed position. Step b1) and/or step b2) are preferably carried out after step a) and/or step b). Alternatively or additionally, step b1) and/or step b2) preferably takes place before step c). Furthermore, step b1) preferably takes place before step b2).

According to one embodiment of the process, it is provided that in the device for producing molded parts provided in step b), the shape of the shaped section is at least in the open position adapted by plastic deformation at least in sections to the shape of the workpiece. In this way, uniform contact of the membrane, in particular in the case of a membrane made of metal, with the workpiece or the molded part to be produced can be achieved, in particular in the case of workpieces or molded parts with complex geometry. Preferably, the shape of the shaped section is at least in the open position adapted by plastic pre-deformation of the shaped section at least in sections to the shape of the workpiece.

### BRIEF DESCRIPTION OF THE DRAWINGS

The invention is explained in more detail below with reference to a drawing showing only preferred embodiments. In the drawing show:

FIG. 1 a first embodiment of the device for producing molded parts in cross-section, with the pressing tools of the device in the open position,

FIG. 2 the device shown in FIG. 1, with a workpiece inserted into the working space of the device and the pressing tools of the device in the open position,

FIG. 3 the device shown in FIG. 1, with a workpiece inserted into the working space of the device and the pressing tools of the device in the closed position,

FIG. 4 a second embodiment of the device for producing molded parts in cross-section, wherein the device comprises two membranes and the pressing tools of the device are in the open position,

FIG. 5 a third embodiment of the device for producing molded parts in cross-section, with the pressing tools of the device in the open position,

FIG. 6 the device of FIG. 5, wherein the membrane is curved about at least two axes extending perpendicular to each other and the pressing tools of the device are in the open position,

FIG. 7a a section of a membrane of the device for producing molded parts with a first surface structure and the structuring applied to the molded part as a result, and

FIG. 7b a section of a membrane of the device for producing molded parts with a second surface structure and the structuring applied to the molded part as a result.

### DESCRIPTION OF THE INVENTION

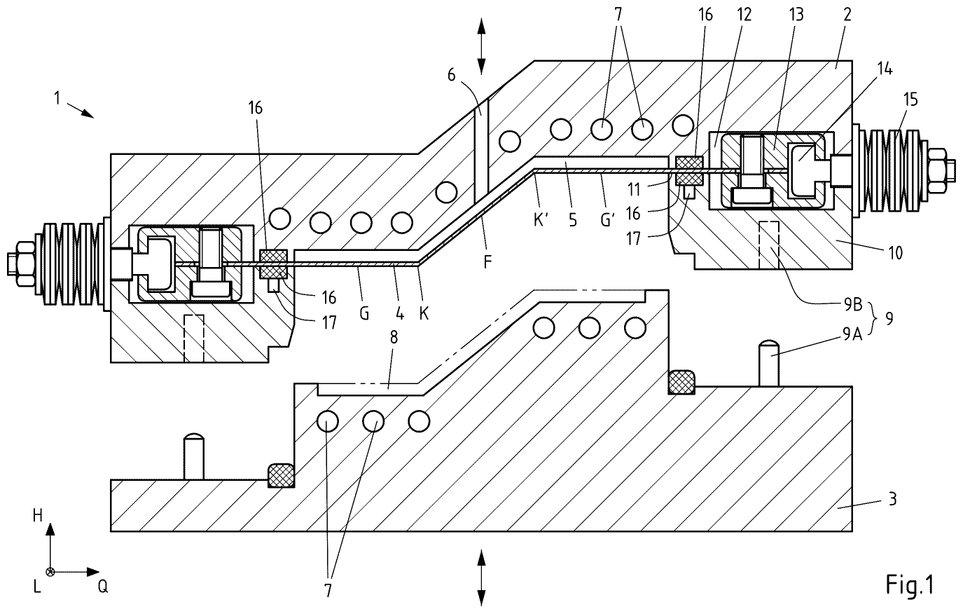

FIG. 1 shows a first embodiment of the device for producing molded parts 1 in cross-section, with the pressing tools 2, 3 of the device in the open position. No workpiece has yet been inserted into the device.

The device 1 comprises a first-upper-pressing tool 2 and a second-lower-pressing tool 3. The two pressing tools 2, 3 can be moved relative to each other between an open position and a closed position, for example in a vertical direction (indicated by arrows in FIG. 1). It is sufficient here if only one of the two pressing tools 2, 3, in particular the first pressing tool 2, is movably mounted.

In addition, the device 1 comprises a membrane 4, which in the present embodiment is connected to the first pressing tool 2. As an alternative to the embodiment shown in FIG. 1, the membrane 4 could, for example, also be connected to the second pressing tool 3. A cavity 5 for a working medium, for example oil, is formed between the membrane 4 and the first pressing tool 2. The membrane 4 is made of metal and preferably has a thickness in the range between 0.05 mm and 4.0 mm. The cavity 5 can be filled with the working medium via a channel 6. Bores 7 are provided in both the first pressing tool 2 and the second pressing tool 3, through which a heating and/or cooling medium can be passed. Alternatively or additionally, the first pressing tool 2 and/or the second pressing tool 3 can also comprise a heating element, in particular an insertable heating plate, which can be inserted into the respective pressing tool 2, 3.

In the design of the device 1 shown in FIG. 1, a working space 8 is formed between the two pressing tools 2, 3, wherein in this case the working space 8 is formed in particular between the membrane 4 and the second pressing tool 3. A workpiece (not shown in FIG. 1) can be inserted into the working space. The two pressing tools 2, 3 preferably have a guide 9, which can be formed, for example, by a projection 9A and a recess 9B, wherein the projection 9A can be provided on the second pressing tool 3 and wherein the recess 9B can be provided on the first pressing tool 2.

The membrane 4 is connected to the first pressing tool 2 in the following way: The first pressing tool 2 has a circumferential edge element 10 which is connected, in particular is screwed, to the first pressing tool 2 (the screw connection is not shown in FIG. 1). A gap 11 is formed between the first pressing tool 2 and its edge element 10, through which the membrane 4 is guided. The gap 11 opens into a cavity 12, in which a clamping device 13 is provided, into which the membrane 4 is clamped. The clamping device 13 is connected to a tie rod 14, which is led out of the first pressing tool 2 and the edge element 10 through an opening and is pressed outwards there by a spring 15 supported on the outer surface, whereby the membrane 4 is provided with a pretension. The spring 15 is part of a device for changing the pretension of the membrane 4.

To seal the cavity 5, a seal 16 is provided in the gap 11, which allows the membrane 4 to move. The seal 16 presses against the membrane 4 with a sealing force. To change the sealing force, a device for changing the sealing force 17 of the seal 16 is provided in the present case.

In the present view shown in FIG. 1, the transverse axis Q of the membrane 4 runs from left to right, the longitudinal axis L of the membrane 4 runs into the image plane of FIG. 1 and the height axis H of the membrane 4 runs from bottom to top. The axes are drawn in FIG. 1 and the following figures accordingly. In FIG. 1, therefore, the transverse extension of the membrane 4 runs substantially from left to right or from right to left and the longitudinal extension of the membrane 4 runs substantially into the image plane of FIG. 1 or out of the image plane of FIG. 1.

The membrane 4 has at least one elastically deformable base section G, G′ for contacting the workpiece, in particular also the molded part to be produced, and at least one plastically pre-deformed shaped section F for contacting the workpiece, in particular also the molded part to be produced. In the embodiment of the device 1 shown here, a first base section G is provided along the transverse extension of the membrane 4, the shaped section F is provided adjoining the first base section G and a second base section G′ is provided adjoining the shaped section F. The shaped section F is plastically pre-deformed in relation to the base sections G, G′. As a result of the plastic pre-deformation, a shape that deviates from the at least one base section G, G′, preferably both base sections G, G′, is imprinted on the shaped section F. In the present embodiment, the shaped section F does not extend parallel to the base sections G, G′, but in sections obliquely to the base sections G, G′. Due to the plastic pre-deformation of the shaped section F, workpieces with complex geometries can be processed with the device 1 and molded parts with complex geometries can be produced. Particularly in the case of devices 1 with a membrane 4 made of metal, elastic deformation of the membrane 4 in order to follow the shape of workpieces or molded parts to be produced with complex geometries is only possible to a certain extent.

Due to the plastic pre-deformation of the shaped section F, the base sections G, G′ are more elastically deformable than the shaped section F. The base sections G, G′ can deform more strongly in the direction of the working space 8 by elastic, in particular linear-elastic, deformation compared to the shaped section F. Nevertheless, the shaped section F can still deform elastically, at least to a certain extent.

In the present case, the shaped section F has a kink K, K′ in each of its outer areas along the transverse extension of the membrane 4. The kinks K, K′ are produced by the plastic pre-deformation of the shaped section F relative to the base sections G, G′. In the area of the kinks K, K′, the shape of the shaped section F has a different curvature to the shape of the base section G, G′, both in terms of the amount of curvature and the sign of the curvature. Thus, the base sections G, G′, in particular the edge area of the respective base section G, G′ adjoining the shaped section, have a curvature of zero, as the base sections G, G′ are each straight. The shaped section F, on the other hand, has a curvature with an amount not equal to zero in the area of the kinks K, K′ and thus a deviation of the curvature in relation to the base sections G, G′.

The deviation of the curvature as well as the presence of an opposite curvature is present here both between the curvature of the shape of the shaped section F on the side of the shaped section F adjoining the cavity 5 and the curvature of the shape of the base sections G, G′, preferably the curvature of the shape of the edge area of the base sections G, G′ adjoining the shaped section F in each case, on the side of the base sections G, G′ adjoining the cavity 5, as well as between the curvature of the shape of the shaped section F on the side of the shaped section F adjoining the working space 8 and the curvature of the shape of the base sections G, G′, preferably the curvature of the shape of the edge region of the base sections G, G′ adjoining the shaped section F in each case, on the side of the base sections G, G′ adjoining the working space 8.

In the present case, the shaped section F extends in sections obliquely, here in particular at an angle of 45°, respectively to the base sections G, G′. The shaped section F is in this case, in particular on the side of the shaped section F adjoining the cavity 5 and on the side of the shaped section F adjoining the working space 8, respectively spaced apart with a distance at least in sections from the first base section G, in particular the edge area of the first base section G adjoining the shaped section F, in the direction of the cavity 5, in particular substantially perpendicular to the surface of the edge region, and in sections from the second base sections G′, in particular the edge region of the second base section G′ adjoining the shaped section F, in the direction of the working space 8, in particular substantially perpendicular to the surface of the edge region, wherein the distance corresponds at least to the membrane thickness.

The deviation of the curvature between the shape of the shaped section F and the shape of the base sections G, G′ is generated in the present case by means of plastic deformation, in particular by means of plastic pre-deformation, of the shaped section F. Despite this plastic deformation or pre-deformation, the membrane thickness of the shaped section F deviates from the membrane thickness of the base sections G, G′ by no more than 40%.

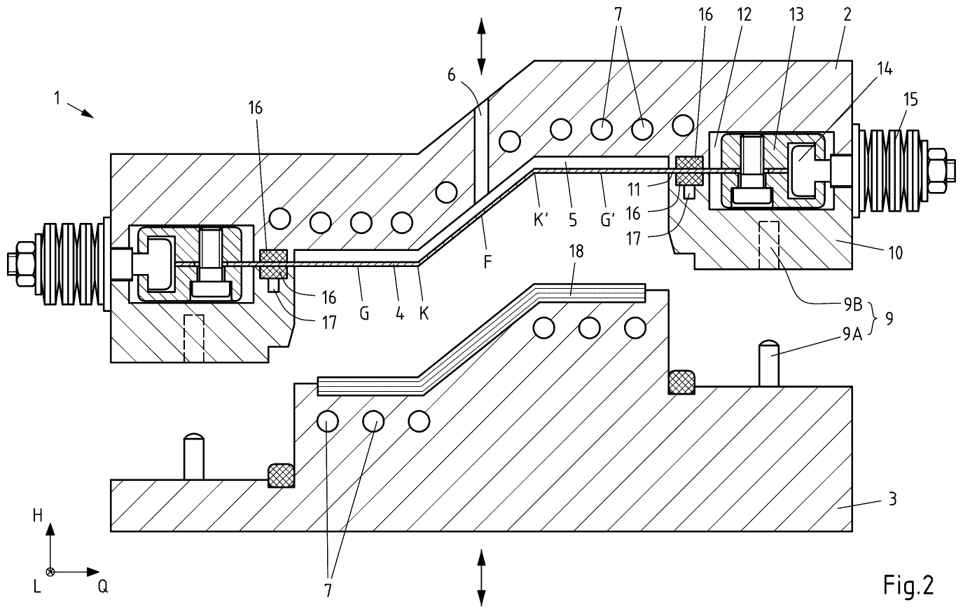

FIG. 2 shows the device of FIG. 1, wherein a workpiece 18 is inserted into the working space 8 of the device 1 and the pressing tools 2, 3 of the device 1 are in the open position. Those areas of the device 1 that have already been described before are provided with corresponding reference signs in FIG. 2. The difference to FIG. 1 is that the workpiece 18 has been inserted into the working space 8.

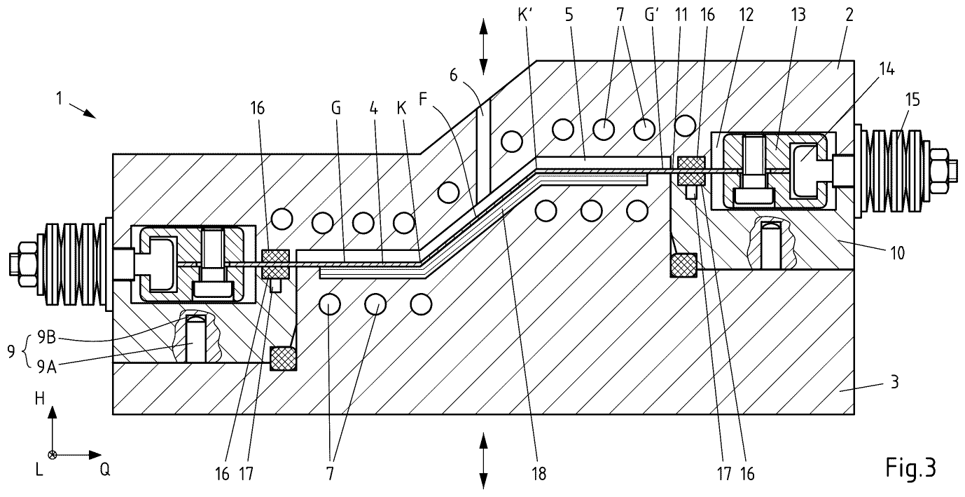

FIG. 3 shows the device 1 of FIG. 1, wherein a workpiece 18 is inserted into the working space 8 of the device 1 and the pressing tools 2, 3 of the device 1 are in the closed position. Those areas of the device 1 that have already been described before are also provided with corresponding reference signs in FIG. 3. The device 1 has been closed and the pressing tools 2, 3 are therefore in the closed position, in that the two pressing tools 2, 3 have been moved towards each other. In the closed position shown in FIG. 3, pressure and temperature is applied to the workpiece 18. Pressure is applied by feeding a working medium, for example oil, through the channel 6 into the cavity 5, whereby the membrane 4 is pressed in the direction of the workpiece 18. Temperature can be applied in different ways: One possibility is to heat the working medium fed through the channel 6 into the cavity 5, so that the heat is transferred from the working medium in the cavity 5 through the membrane 4 to the workpiece 18. Conversely, the working medium could be cooled in order to cool the workpiece 18. Alternatively or additionally, it may be provided that a heating and/or cooling medium flows through the bores 7, whereby the two pressing tools 2, 3 and then also the workpiece 18 can be heated or cooled.

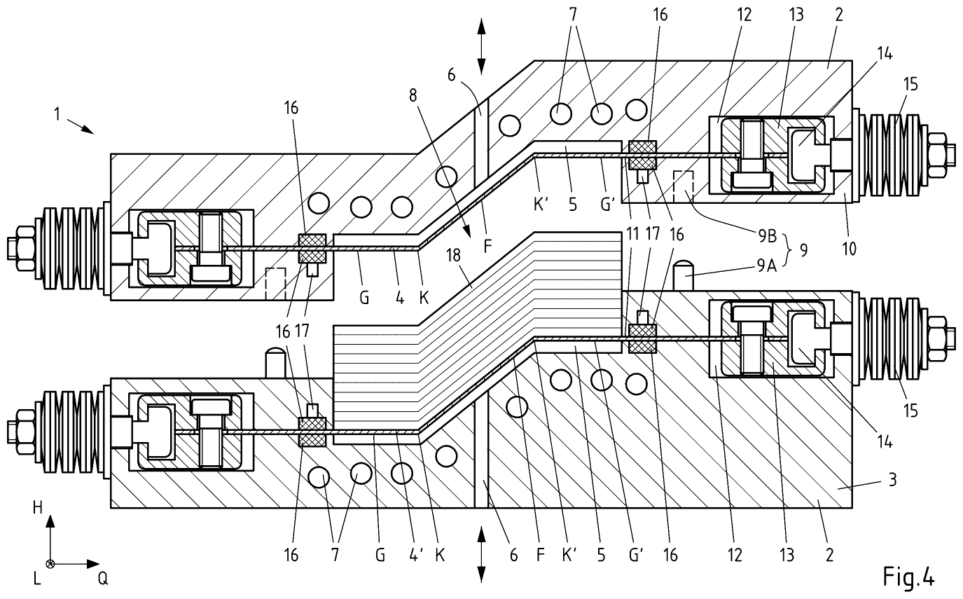

FIG. 4 shows a second embodiment of the device for producing molded parts 1 in cross-section, wherein the device 1 comprises two membranes 4 and the pressing tools 2, 3 of the device 1 are in the open position. In addition, a workpiece 18 is inserted into the working space 8 of the device 1. The second embodiment of the device 1 shown in FIG. 4 differs substantially from the first embodiment of the device 1 shown previously in FIGS. 1 to 3 in that a membrane 4′ is also provided on the second pressing tool 3. Identical components of the embodiments also have the same reference signs in the present case. In the following, substantially only the differences between the embodiments are discussed in more detail.

In the device 1 of FIG. 4, a membrane 4, 4′ is provided on both the first pressing tool 2 and the second pressing tool 3. The first pressing tool 2 and the first membrane 4 connected to it are designed as in FIGS. 1 to 3. In this embodiment, the second pressing tool 3 also comprises a plastically pre-deformed second membrane 4′. The first membrane 4 and the second membrane 4′ are of the same design. Thus, the second membrane 4′ also has a shaped section F due to plastic pre-deformation and two base sections G, G′, wherein the shape of the shaped section F has a different curvature to the shape of the base sections G, G′ at least in sections. By providing two membranes 4, 4′, pressure and temperature can be applied simultaneously to the workpiece 18 from two sides, in this case from above and below. As in the first embodiment of the device 1, the pressing tools 2, 3 can be moved relative to each other from an open position to a closed position (indicated by arrows in FIG. 4). The working space 8 is formed between the first pressing tool 2 and the second pressing tool 3, in particular between the first membrane 4 and the second membrane 4′.

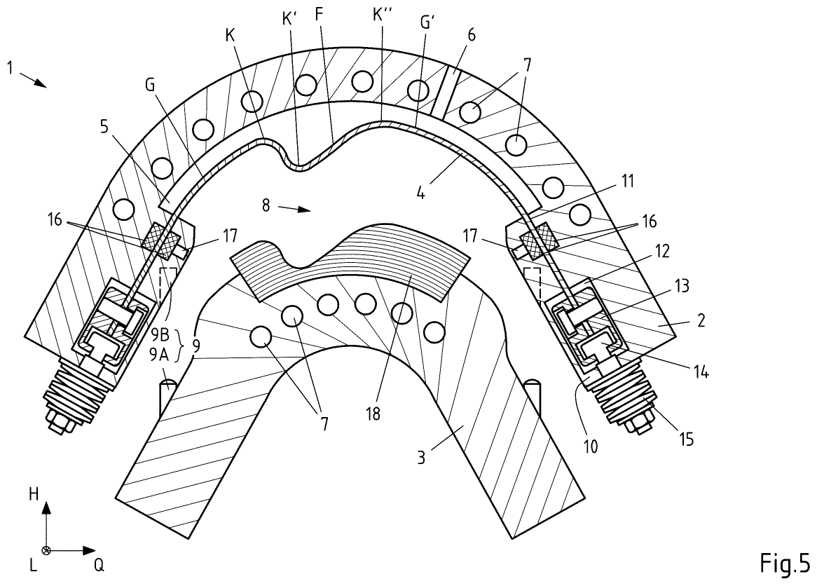

FIG. 5 shows a third embodiment of the device for producing molded parts 1 in cross-section, with the pressing tools 2, 3 of the device 1 in the open position. In addition, a workpiece 18 is inserted into the working space 8 of the device 1. The third embodiment of the device 1 shown in FIG. 5 differs from the first embodiment of the device 1 shown in FIGS. 1 to 3 substantially in the shape of the pressing tools 2, 3 and the shape of the membrane 4. Identical components of the embodiments also have identical reference signs. In the following, substantially only the differences between the embodiments are discussed in more detail.

In the third embodiment of the device 1, the two pressing tools 2, 3 have an substantially circular-arc shape. In addition, sections of the membrane 4 also have an substantially circular arc shape, particularly in the area of the base sections G, G′. The base sections G, G′ substantially have a continuous curvature due to elastic deformation, in this case caused by the force of gravity. The plastically pre-deformed shaped section F has an substantially S-shaped shape due to the plastic pre-deformation, in particular in relation to the base sections G, G′. The shape of the shaped section F is adapted to the complex geometry of the workpiece 18 and the molded part to be produced therefrom, which workpiece 18 is arranged in the working space 8 of the device 1. The curvature of the shape of the shaped section F deviates at least in sections along the transverse extension of the membrane 4 from the curvature of the edge region of the respective base section G, G′ adjoining the shaped section F. In addition, the curvature of the shape of the shaped section F along the transverse extension of the membrane 4 is at least in sections opposite to the curvature of the shape of the edge region of the respective base section G, G′ adjoining the shaped section F. Thus, the curvature of the shape of the shaped section F in the region of the second kink K′ extends opposite to the curvature of the shape of the base sections G, G′.

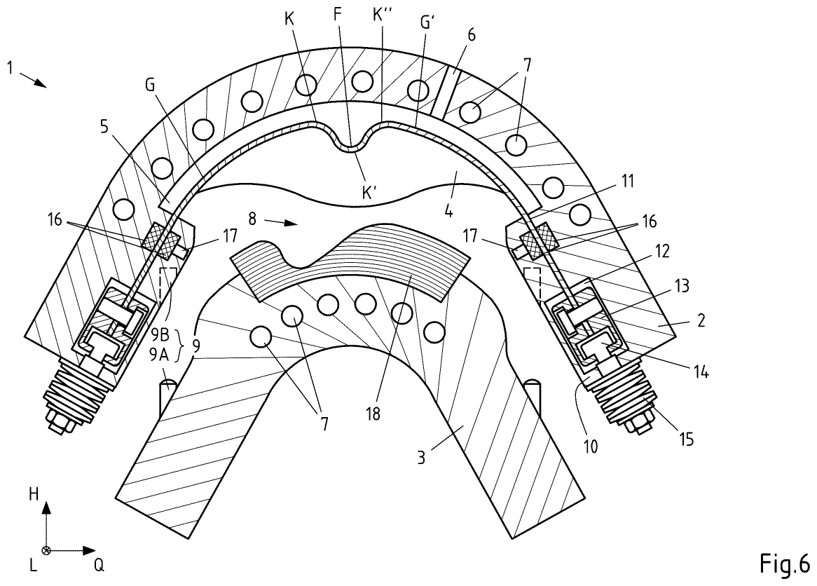

FIG. 6 shows the device 1 from FIG. 5, wherein the membrane 4 is curved around at least two axes running perpendicular to each other and the pressing tools 2, 3 of the device 1 are in the open position. In addition, a workpiece 18 is inserted in the working space 8 of the device 1. FIG. 6 differs from FIG. 5 substantially only in the shape of the membrane 4. Identical components therefore also have identical reference signs. In the following, substantially only the differences will be discussed.

As in FIG. 5, the membrane 4 in FIG. 6 has a plastically pre-deformed shaped section F and two elastically deformable base sections G, G′. However, the membrane 4 shown in FIG. 6 is also curved about at least two mutually perpendicular axes. In particular, the membrane 4 has a curvature about the transverse axis Q and a curvature about the longitudinal axis L for the part of the membrane 4 extending into the image plane of FIG. 6. In the present membrane 4, the shape of the shaped section F is curved about the transverse axis Q and the longitudinal axis L, wherein the shape of the base sections G, G′ is also curved about the transverse axis Q and the longitudinal axis L, at least in sections. This makes it possible to produce molded parts with very complex geometries, such as a double-curved cockpit of an aircraft.

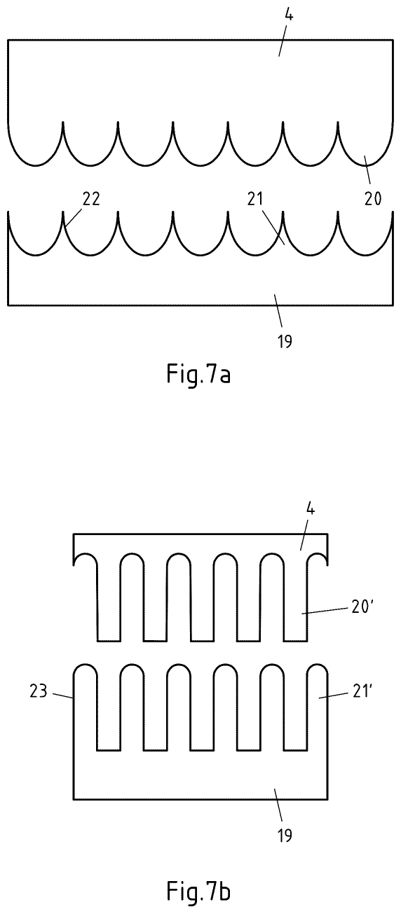

FIG. 7a shows a section of a membrane 4 of the device for producing molded parts 1 with a first surface structure 20 and the structuring 21 applied thereby to the molded part 19. The molded part 19 is produced from the workpiece 18. In FIG. 7a, the structuring 21 is designed as a riblet structure or sharkskin. Due to the riblet structure, the molded part 19 has a low flow resistance. The riblet structure has regularly spaced ribs 22 with sharp tips, whereby the tips are each spaced 50 μm apart in the present embodiment example. The height of the ribs 22 or the depth of the grooves formed by the spaced apart ribs 22 is 70 μm in each case in the present embodiment. The riblet structure on the molded part 19 is embossed on the workpiece 18 and thus the molded part 19 by the surface structure 20 of the membrane 4, wherein the surface structure 20 corresponds to a negative of the riblet structure.

FIG. 7b shows a section of a membrane 4 of the device for producing molded parts 1 with a second surface structure 20′ and the structuring 21′ applied to the molded part 19 as a result. The structuring 21′ of the molded part 19 is finger-like and creates a lotus effect, i.e. it allows water to roll off the surface of the molded part 19. The fingers 23 of the finger-like structuring are approximately 100 μm long, 20 μm wide and each 30 μm spaced apart.

### LIST OF REFERENCE SYMBOLS

1 Device for producing molded parts
2 First pressing tool
3 Second pressing tool
4,4′ Membrane
5 Cavity
6 Channel
7 Bore
8 Working space
9 Guide
9A Projection
9B Recess
10 Edge element
11 Gap
12 Cavity
13 Clamping device
14 Tie rod
15 Spring
16 Seal
17 Device for changing the sealing force
18 Workpiece
19 Molded part
20, 20′ Surface structure
21, 21′ Structuring
22 Rib
23 Finger
F Shaped section
G, G′ Base section
H Height axis
K, K′, K″ Kink
L Longitudinal axis
Q Transverse axis

1. A device for producing molded parts, in particular from fiber composite material, comprising:
a first pressing tool,
a second pressing tool, and
at least one membrane for contacting a workpiece,
wherein the first pressing tool and the second pressing tool are movable relative to one another between an open position and a closed position,
wherein at least in the closed position a cavity for a working medium is formed between the membrane and the first pressing tool and/or the second pressing tool,
wherein a working space for receiving the workpiece is formed between the first pressing tool and the second pressing tool, in particular between the membrane and the first pressing tool and/or the second pressing tool, and
wherein the membrane has a membrane thickness, a longitudinal extension and a transverse extension,
wherein
the membrane has, in particular along the longitudinal extension and/or the transverse extension of the membrane, at least one elastically deformable base section for contacting the workpiece and at least one plastically pre-deformed shaped section for contacting the workpiece.

2. The device according to claim 1,
wherein
at least in the open position, the shaped section is plastically pre-deformed relative to the base section, in particular along the longitudinal extension and/or the transverse extension of the membrane.

3. (canceled)

4. The device according to any one of claim 1,
wherein
the base section is more elastically deformable than the shaped section and/or that the membrane, in particular the base section, is deformable by elastic deformation in the direction of the working space.

5. The device according to claim 1,
wherein
at least in the open position, the curvature of the shape of the shaped section, in particular along the longitudinal extension and/or transverse extension of the membrane, deviates at least in sections from at least one curvature of the shape of the base section, preferably from the curvature of the shape of the edge region of the base section adjoining the shaped section.

6. The device according to claim 5,
wherein
at least in the open position, the curvature of the shape of the shaped section on the side of the shaped section adjoining the cavity deviates at least in sections from the at least one curvature of the shape of the base section, preferably from the curvature of the shape of the edge region of the base section adjoining the shaped section, on the side of the base section adjoining the cavity and/or the curvature of the shape of the shaped section on the side of the shaped section adjoining the working space deviates at least in sections from the at least one curvature of the shape of the base section, preferably from the curvature of the shape of the edge region of the base section-adjoining the shaped section, on the side of the base section adjoining the working space.

7. The device according to claim 1,
wherein
at least in the open position, the curvature of the shape of the shaped section, in particular along the longitudinal extension and/or transverse extension of the membrane, is designed at least in sections opposite to the at least one curvature of the shape of the base section, preferably to the curvature of the shape of the edge region of the base section adjoining the shaped section.

8. The device according to claim 7,
wherein
at least in the open position, the curvature of the shape of the shaped section on the side of the shaped section adjoining the cavity is at least in sections opposite to the at least one curvature of the shape of the base section; preferably to the curvature of the shape of the edge region of the base section adjoining the shaped section, on the side of the base section adjoining the cavity and/or the curvature of the shape of the shaped section on the side of the shaped section adjoining the working space is at least in sections opposite to the at least one curvature of the shape of the base section, preferably to the curvature of the shape of the edge region of the base section adjoining the shaped section, on the side of the base section adjoining the working space.

9. The device according to claim 5,
wherein
the deviation of the curvature of the shape of the shaped section from the at least one curvature of the shape of the base section, preferably from the curvature of the shape of the edge region of the base section adjoining the shaped section, is generated by means of plastic deformation, in particular of the shape, of the shaped section.

10. (canceled)

11. The device according to claim 1,
wherein
at least in the open position, the shaped section and/or the base section, particular the shape of the shaped section and/or the shape of the base section, can be curved at least in sections about the longitudinal axis of the membrane or an axis parallel to the longitudinal axis of the membrane, about the transverse axis of the membrane or an axis parallel to the transverse axis of the membrane and/or about the height axis of the membrane or an axis parallel to the height axis of the membrane.

12. The device according to claim 1
wherein
at least in the open position, the shaped section, in particular on the side of the shaped section adjoining the cavity and/or on the side of the shaped section adjoining the working space, is spaced apart by a distance at least in sections from the base section, in particular the edge region of the base section adjoining the shaped section, in the direction of the cavity and/or in the direction of the working space, in particular substantially perpendicularly to the surface of the edge region of the base section adjoining the shaped section, and that the distance corresponds at least to the membrane thickness.

13. The device according to claim 1,
wherein
at least in the open position, the shaped section extends, in particular along the longitudinal extension and/or transverse extension of the membrane, at least in sections obliquely to the base section and that, preferably, between the shaped section and the base section there is, at least in sections, an angle of at least 90°, preferably at least 100°, in particular at least 120°, and/or an angle of at most 180°, preferably at most 160°, in particular at most 145°.

14. (canceled)

15. The device according to claim 1,
wherein
the membrane thickness of the shaped section deviates at most 40%, preferably at most 25%, further preferably at most 15%, in particular at most 10%, further in particular at most 5%, from the membrane thickness of the base section, in particular of the edge region of the base section adjoining the shaped section.

16. The device according to claim 1,
wherein
the membrane, in particular the base section and/or the shaped section, has at least in sections a surface structure and that, preferably, the surface structure is arranged on the side of the membrane adjoining the working space, in particular of the base section and/or the shaped section.

17. The device according to claim 1,
wherein
the surface of the membrane, in particular of the base section and/or of the shaped section, has at least in sections an average surface roughness of less than 63 μm, preferably less than 12 μm, more preferably between 0.1 μm and 10 μm, in particular between 0.1 um and 3 μm, preferably on the side of the membrane facing the working space.

18. The device according to claim 1,
wherein
the membrane is arranged at least in sections between the first pressing tool and the second pressing tool and/or that the first pressing tool and/or the second pressing tool is connected to the membrane.

19. The device according to claim 1,
wherein
the cavity is sealed at least in the closed position by at least one seal, in that a sealing force can be applied to the membrane via the seal and in that, preferably, the membrane is moveable relative to the seal.

20. The device according to claim 1,
wherein
the first pressing tool and the second pressing tool are movable relative to one another along an axis of movement, in that the first pressing tool and/or the second pressing tool has a first pressing plane and a second pressing plane, and in that the first pressing plane and the second pressing plane of the respective pressing tool are spaced apart from one another in the direction of the axis of movement.

21. device according to claim 1,
wherein
at least one device for changing the pretension of the membrane.

22. (canceled)

23. (canceled)

24. A process for producing molded parts, in particular from fiber composite material, comprising the following steps:
a) Providing a workpiece,
b) Providing a device for producing molded parts according to claim 1, and
c) Applying pressure and/or temperature to the workpiece by means of the device for producing molded parts.

25. The process according to claim 24,
wherein
in the device for producing molded parts provided in step b), the shape of the shaped section is at least in the open position adapted by plastic deformation at least in sections to the shape of the workpiece.
